(19) United States
(12) Patent Application Publication
(10) Pub. No.: US 2024/0104346 A1
(43) Pub. Date: Mar. 28, 2024

(54) METHOD AND DEVICE FOR COMPRESSING GENERATIVE PRE-TRAINED LANGUAGE MODELS VIA QUANTIZATION

(71) Applicant: Huawei Technologies Co., Ltd., Shenzhen (CN)

(72) Inventors: Lu HOU, Shenzhen (CN); Chaofan TAO, Shenzhen (CN); Wei ZHANG, Shenzhen (CN); Lifeng SHANG, Hong Kong (CN); Xin JIANG, Hong Kong (CN); Qun LIU, Hong Kong (CN); Li QIAN, Shenzhen (CN)

(21) Appl. No.: 17/945,978

(22) Filed: Sep. 15, 2022

(51) Int. Cl. G06N 3/04

(52) U.S. Cl. CPC G06N 3/0454

(57) ABSTRACT

A method is provided for quantizing a neural network model performed by a processing system. The method comprises determining a scaling factor based on a distribution of weights associated with the neural network model, determining quantized weights based on the scaling factor and the weights associated with the distribution, determining a training loss of the neural network model based on the quantized weights during training of the neural network model, and determining an updated scaling factor for the neural network model based on a gradient of the training loss.

### TECHNICAL FIELD

This disclosure relates generally to machine learning technologies and, more specifically, to processing data using neural network technologies.

### BACKGROUND

Pre-training and fine-tuning frameworks on large-scale language corpus have been widely used in natural language understanding and generation tasks. Pre-training objectives commonly used in natural language include masked language modeling (“MLM”) and causal language modeling (“CLM”). For example, bidirectional encoder representations from transformers (“BERT”) is an exemplary model of MLM. Generative pre-trained transformer is an exemplary model of CLM. MLM predicts the masked words based on other words in that sentence, which is bi-directional in nature as the masked token “sees” both its left and right tokens. Hence, MLM understands the sequence as a whole and achieve remarkable performance for downstream natural language understanding tasks. For CLM, such as generative pre-training Transformer (“GPT”), it predicts each token in left-to-right sequential order. Due to its unidirectional nature, GPT is suitable for generation tasks, either zero-shot or fully fine-tuned.

Transformer-based generative pre-trained language models (“PLMs”) show strong abilities of multi-task and few-shot learning capabilities, and achieve remarkable performances on a variety of tasks. However, due to the large number of parameters and the token-by-token generation processes in these models, Transformer-based PLMs tend to incur high overhead in terms of computational complexity and memory bandwidth. Numerous approaches have been proposed to compress PLMs, but mostly focus on understanding tasks such as sentence classification using BERT. Recent work attempts to compress GPT-2 using tensor decomposition and knowledge distillation, but achieves much less compression than BERT.

Yet the underlying difficulty of compressing a generative language model remains unclear. Therefore, there is a need to develop a technology that provides solutions to improve model compression in natural language learning applications.

### SUMMARY

In an exemplary embodiment, the present disclosure provides a method for quantizing a neural network model, which is performed by a processing system. The method comprises: a) determining a scaling factor based on a distribution of weights associated with the neural network model, b) determining quantized weights based on the scaling factor and the weights associated with the distribution, c) determining a training loss of the neural network model based on the quantized weights during training of the neural network model, and d) determining an updated scaling factor for the neural network model based on a gradient of the training loss.

In a further exemplary embodiment, the method further comprises determining an average weight magnitude based on the distribution of weights, and determining a clipping factor as a product of the scaling factor and the average weight magnitude. Determining quantized weights based on the weights in the distribution and the scaling factor is based on the clipping factor.

In a further exemplary embodiment, the method further comprises determining the average weight magnitude by an L1 norm function to the weights associated with the distribution.

In a further exemplary embodiment, the weights associated with the distribution are divided into a plurality of value ranges based on the scaling factor. The method further comprises computing a gradient contribution by each weight of the weights associated with the distribution based on the value range that the respective weight falls in, and computing the gradient of the training loss by aggregating the gradient contributions from the weights associated with the distribution.

In a further exemplary embodiment, the method further comprises setting an initial value of the scaling factor to one.

In a further exemplary embodiment, the method further comprises determining, based on initial values of the weights in the neural network model, an initial value for the scaling factor.

In a further exemplary embodiment, the method further comprises determining an optimized scaling factor for a task by carrying out multiple iterations of a) through d).

In a further exemplary embodiment, the updated scaling factor is associated with one weight matrix among a plurality of weight matrices in the neural network model. The method further comprises determining an updated scaling factor for each of the other weight matrices in the plurality of weight matrices in the neural network model by carrying out a) through d) for the respective weight matrix.

In a further exemplary embodiment, the method further comprises applying the updated scaling factors to the neural network model, determining quantized weights associated with the updated scaling factors as learnable weights in the neural network model, and updating the neural network model by updating the learnable weights.

In a further exemplary embodiment, the neural network model with the quantized weights associated with the updated scaling factors is included in a student network. The student network is trained with a teacher network. The method further comprises obtaining a set of first token representations by the student network and a set of second token representations by the teacher network based on an input sequence, determining a first loss based on pair-wise comparison between first tokens in the set of first token representations and second tokens in the set of second token representations, determining a third loss during training of the student network based on the first loss, and updating the student network based on the third loss.

In a further exemplary embodiment, the first loss comprises a student-to-teacher loss and a teacher-to-student loss.

In a further exemplary embodiment, the method further comprises obtaining a set of first logits from the student network and a set of second logits from the teacher network based on the input sequence, determining a second loss based on pair-wise comparison between each first logit in the set of first logits and respective second logit in the set of second logits, and determining the third loss based on the first loss and the second loss.

In a further exemplary embodiment, the determining of the third loss based on the first loss and the second loss further comprises determining the third loss by aggregating the first loss and the second loss with a tunable factor.

In another exemplary embodiment, the present disclosure provides a system for quantizing a neural network model. The system comprises one or more processors and a non-transitory computer-readable medium having computer-executable instructions stored thereon. The computer-executable instructions, when executed by one or more processors, causing the one or more processors to facilitate a) determining a scaling factor based on a distribution of weights associated with the neural network model, b) determining quantized weights based on the scaling factor and the weights associated with the distribution, c) determining a training loss of the neural network model based on the quantized weights during training of the neural network model, and d) determining an updated scaling factor for the neural network model based on a gradient of the training loss.

In a further exemplary embodiment, the one or more processors further facilitate determining an average weight magnitude based on the distribution of weights, and determining a clipping factor as a product of the scaling factor and the average weight magnitude. Determining quantized weights based on the weights in the distribution and the scaling factor is based on the clipping factor.

In a further exemplary embodiment, the weights associated with the distribution are divided into a plurality of value ranges based on the scaling factor. The one or more processors further facilitate computing a gradient contribution by each weight of the weights associated with the distribution based on the value range that the respective weight falls in, and computing the gradient of the training loss by aggregating the gradient contributions from the weights associated with the distribution.

In a further exemplary embodiment, the updated scaling factor is associated with one weight matrix among a plurality of weight matrices in the neural network model. The one or more processors further facilitate determining an updated scaling factor for each of the other weight matrices in the plurality of weight matrices in the neural network model by carrying out a) through d) for the respective weight matrix.

In a further exemplary embodiment, the one or more processors further facilitate applying the updated scaling factors to the neural network model, determining quantized weights associated with the updated scaling factors as learnable weights in the neural network model, and updating the neural network model by updating the learnable weights.

In a further exemplary embodiment, the neural network model with the quantized weights associated with the updated scaling factors is included in a student network. The student network is trained with a teacher network. The one or more processors further facilitate obtaining a set of first token representations by the student network and a set of second token representations by the teacher network based on an input sequence, determining a first loss based on pair-wise comparison between first tokens in the set of first token representations and second tokens in the set of second token representations, obtaining a set of first logits from the student network and a set of second logits from the teacher network based on the input sequence, determining a second loss based on pair-wise comparison between each first logit in the set of first logits and respective second logit in the set of second logits, determining a third loss during training of the student network based on the first loss and the second loss, and updating the student network based on the third loss.

In yet another exemplary embodiment, the present disclosure provides a non-transitory computer-readable medium having processor-executable instructions stored thereon for quantizing a neural network model. The computer-executable instructions, when executed by one or more processors, cause the one or more processors to facilitate a) determining a scaling factor based on a distribution of weights associated with the neural network model, b) determining quantized weights based on the scaling factor and the weights associated with the distribution, c) determining a training loss of the neural network model based on the quantized weights during training of the neural network model, and d) determining an updated scaling factor for the neural network model based on a gradient of the training loss.

### BRIEF DESCRIPTION OF THE DRAWINGS

The system and method for data processing are described in detail below with reference to the attached drawing figures, wherein:

FIG. 1A illustrates an exemplary network environment, in accordance with one or more examples of the present disclosure.

FIG. 1B illustrates an exemplary computer system, in accordance with one or more examples of the present disclosure.

FIGS. 2A and 2B are diagrams showing exemplary weight distributions based on weights provided by a 12-layer full-precision GPT-2 model.

FIG. 3 is an exemplary process of data processing, in accordance with one or more examples of the present disclosure.

FIG. 4 demonstrates an exemplary training workflow, in accordance with one or more examples of the present disclosure.

FIG. 5 is an exemplary process of data processing, in accordance with one or more examples of the present disclosure.

### DETAILED DESCRIPTION

Systems and methods are disclosed related to quantization-based compression techniques that provide solutions for compressing generative language models with improved performance, e.g., increased compression ratios. The quantization-based compression techniques in the present disclosure may be used to obtain quantized/compressed models, which may be widely used in various tasks, such as dialog systems, question answering, poetry generation, code generation, and image generation in various products. Examples of products include but not limited to cloud systems, terminal devices, autonomous vehicles, etc. Model compression may be realized based on the technology of the present disclosure, which may greatly improve the storage capacity required for carrying a huge model and the inference speed of the model. Therefore, the technology of the present disclosure may greatly save the budget of providing cloud services based on generative language models.

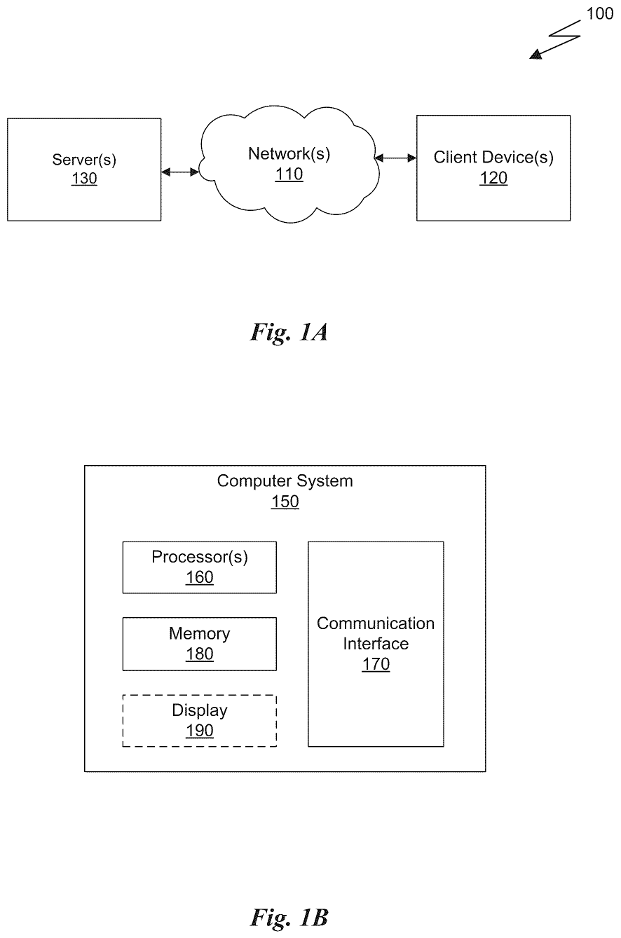

FIG. 1A illustrates an exemplary network environment 100, in accordance with one or more examples in the present disclosure. Machine learning techniques implementing the various embodiments disclosed herein may take place in the exemplary network environment 100. Network environments suitable for use in implementing embodiments of the disclosure may include one or more client devices 120, servers 130, and/or other device types.

Components of a network environment may communicate with each other via a network(s) 110, which may be wired, wireless, or both. By way of example, network 110 may include one or more Wide Area Networks (“WANs”), one or more Local Area Networks (“LANs”), one or more public networks such as the Internet, and/or one or more private networks. Where the network includes a wireless telecommunications network, components such as a base station, a communications tower, access points, or other components may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (“APIs”)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). A cloud-based network environment may be private (e.g., limited to a single organization), may be public (e.g., available to many organizations), and/or a combination thereof (e.g., a hybrid cloud environment).

Client device(s) 120 may include at least some of the components, features, and functionality of the exemplary computer system 150 of FIG. 1B. By way of example and not limitation, a client device 120 may be embodied as a Personal Computer (“PC”), a laptop computer, a mobile device, a smartphone, a tablet computer, a virtual reality headset, a video player, a video camera, a vehicle, a virtual machine, a drone, a robot, a handheld communications device, a vehicle computer system, an embedded system controller, a workstation, an edge device, any combination of these delineated devices, or any other suitable device.

FIG. 1B illustrates a block diagram of an exemplary computer system 150 configured to implement various functions according to one or more embodiments in the present disclosure. In some examples, computer system 150 may be implemented in client device 120 or server 130 in network environment 100 as shown in FIG. 1A. One or more computing systems 150, one or more client devices 120, one or more servers 130, or the combination thereof may form a processing system to perform the processes in the present disclosure.

As shown in FIG. 1B, computer system 150 may include one or more processors 160, a communication interface 170, a memory 180, and a display 190. Processor(s) 160 may be configured to perform the operations in accordance with the instructions stored in memory 180. Processor(s) 160 may include any appropriate type of general-purpose or special-purpose microprocessor (e.g., a CPU or GPU, respectively), digital signal processor, microcontroller, or the like. Memory 180 may be configured to store computer-readable instructions that, when executed by processor(s) 160, can cause processor(s) 160 to perform various operations disclosed herein. Memory 180 may be any non-transitory type of mass storage, such as volatile or non-volatile, magnetic, semiconductor-based, tape-based, optical, removable, non-removable, or other type of storage device or tangible computer-readable medium including, but not limited to, a read-only memory (“ROM”), a flash memory, a dynamic random-access memory (“RAM”), and/or a static RAM.

Communication interface 170 may be configured to communicate information between computer system 150 and other devices or systems, such as client device 120 and/or server 130 as show in FIG. 1A. For example, communication interface 170 may include an integrated services digital network (“ISDN”) card, a cable modem, a satellite modem, or a modem to provide a data communication connection. As another example, communication interface 170 may include a local area network (“LAN”) card to provide a data communication connection to a compatible LAN. As a further example, communication interface 170 may include a high-speed network adapter such as a fiber optic network adaptor, 10 G Ethernet adaptor, or the like. Wireless links can also be implemented by communication interface 170. In such an implementation, communication interface 170 can send and receive electrical, electromagnetic or optical signals that carry digital data streams representing various types of information via a network. The network can typically include a cellular communication network, a Wireless Local Area Network (“WLAN”), a Wide Area Network (“WAN”), or the like.

Communication interface 170 may also include various I/O devices such as a keyboard, a mouse, a touchpad, a touch screen, a microphone, a camera, a biosensor, etc. A user may input data to computer system 150 (e.g., a terminal device) through communication interface 170.

Display 190 may be integrated as part of computer system 150 or may be provided as a separate device communicatively coupled to computer system 150. Display 190 may include a display device such as a Liquid Crystal Display (“LCD”), a Light Emitting Diode Display (“LED”), a plasma display, or any other type of display, and provide a Graphical User Interface (“GUI”) presented on the display for user input and data depiction. In some embodiments, display 190 may be integrated as part of communication interface 170.

Model compression techniques disclosed herein may be configured to deploy state-of-the-art deep networks in devices with low power and resources without significantly compromising the accuracy of a language model. By compressing or reducing the size and/or latency of the model, the model may have fewer parameters and require less RAM capacity. A latency reduction is a decrease in the time it takes for the model to make a prediction or inference, based on an input to the model, thereby resulting in lower energy consumption at runtime. As a result, a model compression reduces CPU/GPU time, memory usage, and disk storage, making language models suitable for production that were previously too expensive, slow, or large.

Processes for model compression may include pruning, quantization, low-rank approximation and sparsity, knowledge distillation, and neural architecture search (“NAS”). Pruning involves removing connections between neurons or entire neurons, channels, or filters from a trained network, such that pruning compresses models by reducing the number of weights. Quantization in general is the process of mapping values from a large set to values in a smaller set, meaning that the output consists of a smaller range of possible values than the input, ideally without losing too much information in the process. In other words, quantization decreases the size of the weights. The goal of low-rank approximation is to approximate the numerous, redundant weights of a layer using a linear combination of fewer weights. Knowledge distillation is the idea of transferring the knowledge from a large trained model (or ensemble of models) to a smaller model for deployment by training it to mimic the larger model's output. NAS in the most general sense is a search over a set of decisions that define the different components of a neural network—it is a systematic, automated way of learning optimal model architectures.

In the present disclosure, a quantization method implemented with module-wise dynamic scaling is used to reduce the clipping factor's sensitivity to initialization, combined with an improved gradient estimation that considers weights within the clipping range, contrary to conventional methods. The clipping factor learned by the quantization method of the present disclosure provides finer resolutions for most weights. In some examples, quantized models are further implemented by applying token-level contrastive distillation learning, which helps alleviate the word collapse problem by making token representations more distinguishable. In some embodiments, token-level contrastive distillation learning may outperform sequence-level counterparts. Sequence-level knowledge distillation (“SLKD”) is a model compression technique that leverages large, accurate teacher models to train smaller, under-parameterized student models.

To illustrate as an example, a general formulation of quantization-aware training used in compressing generative PLMs is described hereinafter. A language model is a probability distribution over sequences of words in a given language L. A vectorized full-precision weight is denoted as w. Given a sequence of length n (e.g., including n number of tokens in the sequence), a language model assigns a probability P(w₁, . . . , wₙ) to the whole sequence.

Quantization is the process of mapping full-precision values to a smaller set of discrete finite values. For example, most deep network models trained on GPU use the 32-bit floating point (“FP32”) format as full-precision, where data is represented as a 32-bit floating point number. A clipping factor is associated with the range of the set of discrete finite values, for example, by defining the maximum absolute value in the set of discrete finite values. Quantization for deep learning networks is an important step to help accelerate inference as well as to reduce memory and power consumption on embedded devices. The difference between an input value and its quantized value, such as round-off error, is referred to as quantization error. A device or algorithmic function that performs quantization is referred to as a quantizer.

Quantization-aware training trains a quantized network, also referred to as a quantized model, from scratch or from a trained full-precision network (e.g., PLMs). Quantization may be performed in different manners. For instance, binarization converts each weight value to one of “−1” or “+1.” Ternarization converts each weight value to one of “−1,” “0,” or “+1.” Furthermore, a b-bit quantization may be performed as a linear quantization, which quantizes each weight value to

$$Q = \{ - 1 , - \frac{k - 1}{k} , … , - \frac{1}{k} , 0 , \frac{1}{k} , … , \frac{k - 1}{k} , 1 \} ,$$

where k=2^{b-1}−1. Alternatively, a b-bit quantization may be performed as a logarithmic quantization, which quantizes each weight value to

$$Q = \{ - 1 , - \frac{1}{2} , … - \frac{1}{{2}^{k - 1}} , 0 , \frac{1}{{2}^{k - 1}} , … , \frac{1}{2} , 1 \} ,$$

where k=^{2b-1}−1.

A linear quantization is described as an example in the present disclosure for the purpose of illustration. It will be appreciated that the embodiments of the present disclosure may be readily extended to other types of quantization. When performing a quantization-based compression on a PLM, each forward propagation first clips the weight by a positive clipping factor α, and then quantizes the clipped weight to b-bit as follows:

$${w}_{q} = α \cdot Q ( \frac{clip ( w , - α , α )}{α} ) \qquad ( Eq . 1 )$$

where Q(⋅) is a quantization function that maps each entry in clip(w, −α, α) to its closest quantized value in a set of uniform discrete values

$$\{ - 1 , - \frac{k - 1}{k} , … - \frac{1}{k} , 0 , \frac{1}{k} , … , \frac{k - 1}{k} , 1 \}$$

and k=^{2b-1}−1. As such, the training loss [symbol] (w_{q}) may be computed based on w_{q}. During the back propagation, gradients with regard to the quantized weights ∇ [symbol] (w_{q}) may be used to update the full-precision weights w due to the non-differentiability of Q(⋅) For example, a straight-through estimator (“STE”) may be used to transform the gradients based on the quantized weights w_{q} to gradients associated with the weigths w. STE may be used to estimate the gradients of a function, which ignores the derivative of the threshold function and passes on the incoming gradient as if the function was an identity function. The computed gradients are used for updating the learnable weights in the model.

An ideal clipping factor is expected to take the majority of the full-precision weights into account via clipping. In order words, an ideal clipping factor quantizes an optimal range, in which data are densely distributed, thereby reducing quantization errors. Various techniques may be used to facilitate the quantization process. According to some embodiments, a learnable clipping factor may be used for quantization. For example, the parameterized clipping activation (“PACT”) technique parameterizes the clipping factor as an activation clipping parameter and trains a neural network to predict the optimal activation clipping parameter. The PACT technique typically learns the clipping factor α through gradient descent. A learned step size quantization (“LSQ”) technique learns a step size α/n instead of the clipping factors, which requires careful initialization and gradient updates.

Experimental results show varied distributions over weight values embedded in neural network models. For example, a generative pre-trained Transformer 2 (“GPT-2”), which is an open-source artificial intelligence (“AI”) created by OPENAI, is a large transformer-based language model with 1.5 billion parameters including various learnable weights. The GPT-2 has a twelve-layer architecture, which includes various functional modules embedded in the layers of the model, such as multi-head attention modules and linear layers. Each functional module is associated with one or more matrices of learnable weights. For instance, a multi-head attention module is associated with an output projection matrix wₒ, and a linear layer is associated with a matrix w_{g}.

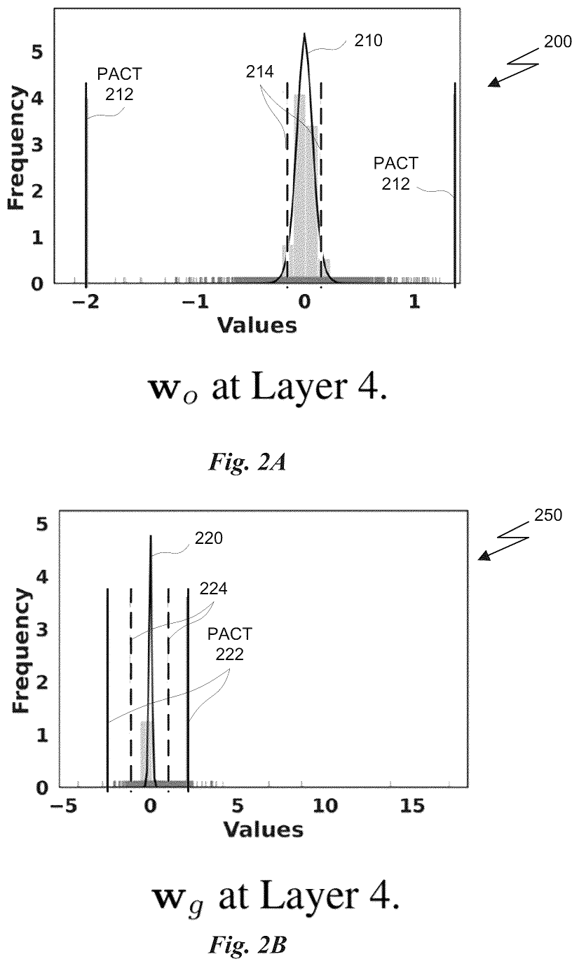

FIGS. 2A and 2B are diagrams showing exemplary weight distributions based on weights provided by a 12-layer full-precision GPT-2. In particular, diagram 200 in FIG. 2A shows a distribution, fitted by a curve 210, of an output projection matrix wₒ, in the multi-head attention module in the feed-forward network of the fourth layer from the 12-layer full-precision GPT-2, and predictions of clipping factors by existing techniques, such as PACT 212, and the technique 214 disclosed herein. Diagram 250 in FIG. 2B shows a distribution, fitted by a curve 220, of a weight matrix w_{g} in the second linear layer in the feed-forward network of the fourth layer from the 12-layer full-precision GPT-2, and predictions of clipping factors by existing techniques, such as PACT 222 and the technique 224 disclosed herein.

As indicated in FIGS. 2A and 2B, the weight distributions may be highly skewed with outliers, which may lead to difficulty in estimating the clipping factor α of the quantizer by using existing methods, such as PACT. As mentioned above, PACT learns the clipping factor α through gradient descent. For example, in PACT, the approximation of gradient of the clipping factor α depends only on certain weights whose absolute values are greater than α, i.e., |w|≥α. That said, the solution provided by PACT ignores the effect of weights in the range [−α, α] and relies heavily on the initialization of α. As shown in FIG. 2B, PACT predicts a larger clipping factor for quantization than the technique of the present disclosure. FIG. 2A shows that in more extreme cases when PACT employs an improper initialization and inaccurate gradient estimates for the clipping factor, PACT may predict a clipping factor α that is too large to provide a fine resolution for most weights in the clipping range. A coarse resolution may result in a large quantization error, i.e., a large difference between the input value and the quantized value. Furthermore, quantization errors can accumulate over time, such as through token-by-token sequential generation via CLM during inference, which makes this problem even worse.

In view of the varied weight distributions, the present disclosure provides a technical solution to mitigated the above-described issues with the varied weight distributions. The technique disclosed herein is referred to as module-dependent dynamic scaling, which may be used to determine scaling (related to clipping factors) based on statistics of individual module weights. In particular, this technique obtains the clipping factor α based on a new scaling factor γ and the average weight magnitude

$$\frac{{‖ w ‖}_{1}}{n} ,$$

by applying:

$$α = γ \cdot \frac{{‖ w ‖}_{1}}{n} , \qquad ( Eq . 2 )$$

where ∥⋅∥₁ is an L1 norm function, i.e., to obtain the sum of the magnitudes of the vectors in vector space, n is the number of weights in the respective weight distribution. In some examples, the scaling factor γ may be initialized as one, which not only eases initialization, but also ensures that the initial clipping factor α does not deviate far from the full-precision weights, regardless of the diversity of the weight distribution. Furthermore, this technique provides a more accurate way to estimate the gradient of the scaling factor α compared to conventional methods, by considering the weights inside the clipping range, i.e., |w|<α. In particular, the gradient with regard to γ is calculated as the summation of contributions from each weight, which is formulated as:

$$\frac{\partial ℓ}{\partial γ} = {\sum }_{i = 1}^{n} \frac{\partial ℓ}{\partial [ {w}_{q} ] \_i} \frac{\partial [ {w}_{q} ] \_i}{\partial γ} . \qquad ( Eq . 3 )$$

The gradient contributed by each weight, i.e.,

$$\frac{\partial ℓ}{\partial [ {w}_{q} ] \_i} \frac{\partial [ {w}_{q} ] \_i}{\partial γ} ,$$

is computed as:

$$\frac{\partial ℓ}{\partial [ {w}_{q} ] \_i} Q ( {u}_{i} ) \frac{{‖ w ‖}_{1}}{n} , w < - α , \qquad ( Eq . 4 a )$$

$$\frac{\partial ℓ}{\partial [ {w}_{q} ] \_i} [ - \frac{{w}_{i}}{α} + Q ( {u}_{i} ) ] \frac{{‖ w ‖}_{1}}{n} , \qquad ( Eq . 4 b )$$

$$- α \leq w < α ,$$

$$\frac{\partial ℓ}{\partial [ {w}_{q} ] \_i} Q ( {u}_{i} ) \frac{{‖ w ‖}_{1}}{n} , w > α , \qquad ( Eq . 4 c )$$

where [symbol] is the total training loss and uᵢ=clip(wᵢ, −α, α). In one embodiment, the update of the clipping factor may be influenced by both weights outside and inside [−α, α], since a controls the quantization error of both ranges. For example, a large clipping factor may result in a small quantization error for weights outside [−α, α] and a large quantization error for weights inside [−α, α]. The estimation of the gradient of the scaling factor γ in above Equations 3 and 4a-4c balances both weights outside and inside the range [−α, α]. Moreover, the computed scaling is less sensitive to the varied weight distribution, since the gradient of scaling ∂ [symbol] /∂γ is proportional to the average weight magnitude

$$\frac{{‖ w ‖}_{1}}{n} .$$

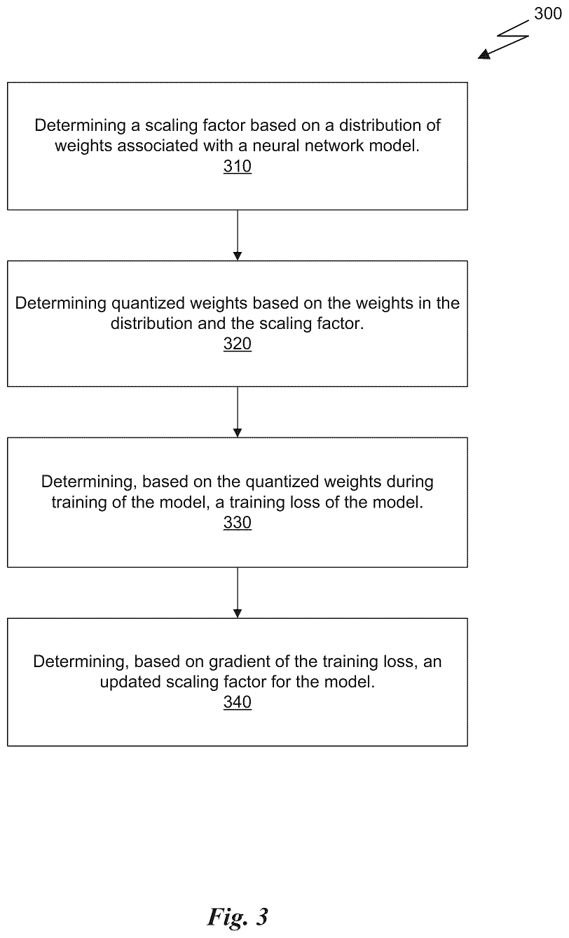

FIG. 3 is an exemplary process 300 of data processing, in accordance with one or more examples of the present disclosure. Process 300 may be performed by a processing system including one or more computer systems 150 as illustrated in FIG. 1B, which may be embodied as one or more client devices 120, one or more servers 130, or a combination thereof in network environment 100 as depicted in FIG. 1A. Process 300 may be performed alone or in combination with other processes in the present disclosure. It will be appreciated by one of skill in the art that process 300 may be performed in any suitable environment and blocks in process 300 may be performed in any suitable order.

At step 310, the processing system determines a scaling factor based on a distribution of weights associated with a neural network model.

In some examples, the neural network model may be a PLM with a plurality of functional modules. Each functional module may be associated with one or more weight matrices. The processing system may obtain the weight matrices provided by the PLM and determine a weight distribution associated with any of the functional modules, thereby determining a scaling factor γ associated with the respective weight distribution. The scaling factor γ is referred to as the module-wise dynamic scaling for the respective functional module. In further examples, the processing system may apply Equation 2 to obtain the clipping factor α associated with the determined scaling factor γ.

In some variations, the neural network model may be a model to be trained from scratch. In this case, the processing system may determine an initial value for the scaling factor γ. For instance, the scaling factor γ may be initialized as one. Alternatively, the processing system may apply step 310 of process 300 based on initial value of the learnable weights in the model to obtain the initial value for the scaling factor γ.

At step 320, the processing system determines quantized weights based on the weights in the distribution and the scaling factor. In particular, the processing system may apply Equation 2 to obtain the clipping factor α associated with the determined scaling factor γ. Then, the processing system may apply Equation 1 to the weights w in the model to obtain the quantized weights w_{q}.

The determined clipping factor α may be combined with various techniques to facilitate the quantization of the weights in the model. To illustrate, in an exemplary transformer-based model of bidirectional encoder representations from transformers (“BERT”), the processing system may perform a layer-wise quantization in the transformer layers and a row-wise quantization in the embedding layer, where each transformer layer and embedding layer may include one or more functional modules in the model. Particularly, the former is to apply one clipping factor for weights in each weight matrix for all weight matrices (e.g., associated with one or more functional modules) in the transformer layers, and the latter is to apply one clipping factor for each word embedding in the respective embedding layer. In some instances, the processing system may use an asymmetric uniform quantization for activations after self-attention (layers) and Gaussian error linear units (“GeLU”) function whose elements (e.g., weights) are mostly positive, and a symmetric uniform quantization for other activations. In some variations, the processing system may not quantize layer-normalization layers, skip connections, biases in the model, due to small computational overheads of these functional modules in the model.

At step 330, the processing system determines a training loss of the model based on the quantized weights during training of the model. For instance, the processing system may compute the training loss [symbol] (w_{q}) based on quantized weights w_{q} during a forward propagaton. During a back propagation, the gradient ∂ [symbol] /θγ with regard to the scaling factor γ may be computed by applying Equations 3 and 4a-4c, which may be used to update the respective scaling factor in the model. In some instances, gradients with regard to the quantized weights ∇ [symbol] (w_{q}) may be used to update the weights w in the model. In some examples, the STE may be used to transform the gradients based on the quantized weights w_{q} to gradients associated with the weigths w. The computed gradients associated with the weights may be used for updating the learnable weights in the model.

At step 340, the processing system determines an updated scaling factor based on the gradient of the training loss. In some variations, the updated learnable weights in the model may be updated in the model during training, leading to changes in weight distributions. The processing system may re-compute the weight distributions in the model, thereby determining an updated scaling factor based on the updated weights. The processing system may dynamically scale the clipping factor α based on statistics of individual module weights in the model during training.

The processing system may run a number of iterations of process 300 to repeatedly perform some or all of the steps to train the model implemented thereon, so that the processing system may determine optimal scaling factors and corresponding optimal clipping factors for the functional modules included in the model. As a result, the processing system may obtain a trained model optimized for a specific task (e.g., a downstream task). The processing system may use the trained model during an inference.

As mentioned above, the compression ratio achieved by conventional quantization methods may be much smaller than that of the BERT. In natural language processing (“NLP”), word embedding is a term used for the representation of words for text analysis, typically in the form of a real-valued vector that encodes the meaning of the word such that the words that are closer in the vector space are expected to be similar in meaning. Word embedding may be obtained using a set of language modeling and feature learning techniques where words or phrases from the vocabulary are mapped to vectors of real numbers. Word embedding of the full-precision model may be scattered in the vector space and therefore distinguishable. One difficulty with quantizing generative PLMs is that learned word embedding may tend to be homogeneous and indistinguishable due to the reduced capacity caused by quantization. Empirical results show that word embedding learned by models applying common quantization methods, such as PACT and LSQ, may become homogeneous. For example, learned word embedding may become clustered in the vector space and thus less distinguishable. A direct consequence of homogeneous word embedding is that the higher degree of homogeneity in the word embedding of a quantized model, the less the dependencies between different tokens. Furthermore, the weight distributions of different modules and/or different transformer layers also vary widely. These problems may be further worsen by the nature of sequential left-to-right prediction that lies in the generative PLMs, as quantization errors accumulate across time. For instance, the GPT computes each token in a left-to-right order and, thus, quantization errors incurred in the previous tokens are passed onto future tokens, making the learning signal noisier over time, ultimately resulting in less informative word embedding.

In a further example, a quantization method, referred to as token-level contrastive distillation, may be implemented in a quantized model to alleviate the problem of homogeneous word embedding in quantized models. In the present disclosure, a sequence-level operation refers to an operation performed on an input (i.e., a sequence) to a neural network, while a token-level operation refers to an operation performed on tokens representing elements in the input, e.g., segments of the input. A token is an instance of a sequence of characters (e.g., related to a word) in some particular document that are grouped together as a useful semantic unit for processing. A token-level contrastive distillation compares between tokens instead of sequences (i.e., input sequences) to learn a distinguishable representation for each token.

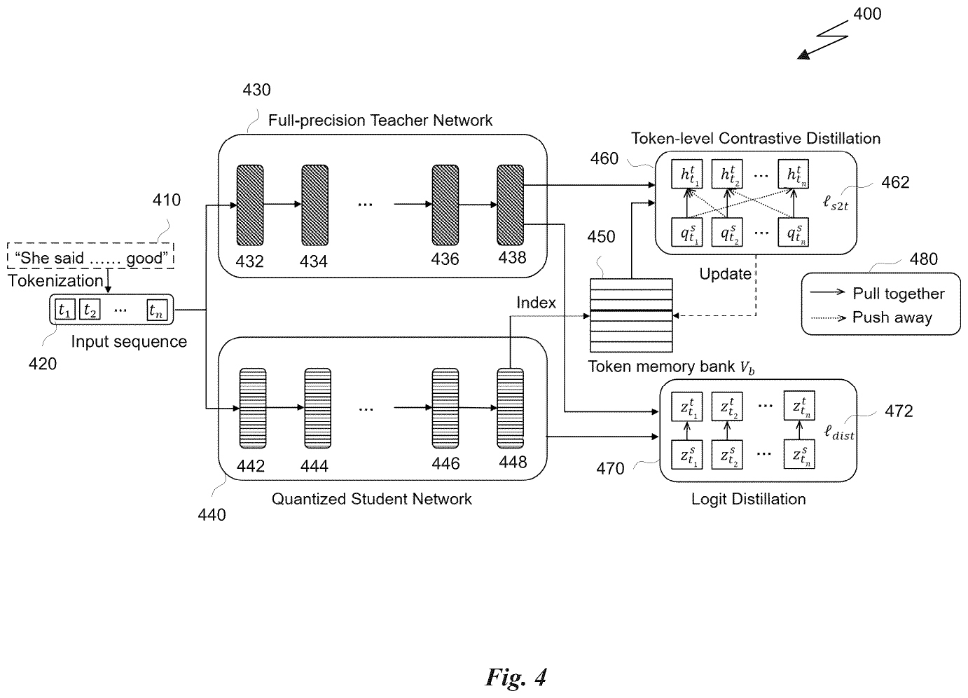

FIG. 4 demonstrates an exemplary training process 400, in accordance with one or more examples of the present disclosure. Some or all of steps of processes 400 may be performed by a processing system including one or more computer systems 150 as illustrated in FIG. 1B, which may be embodied as one or more client devices 120, one or more servers 130, or a combination thereof in network environment 100 as depicted in FIG. 1A. Process 400 may be performed alone or in combination with other processes in the present disclosure. It will be appreciated by one of skill in the art that process 400 may be performed in any suitable environment and in any suitable order.

As an example, the processing system may use process 400 to train a quantized model, which may be compressed based on a full-precision model by applying quantization methods. For example, scaling factors determined by using process 300 may be applied to quantize the learnable weights in the full-precision model to obtain the quantized model. According to embodiments of process 400, the quantized model under training may exploit results generated by the corresponding full-precision model to improve the learning performance, by performing the processes demonstrated in process 400 per iteration.

Block 410 shows an exemplary sequence (e.g., text) to be processed by the quantized model. The sequence may be parameterized into n number of tokens t₁, t₂, . . . , tₙ via a process of tokenization, to obtain an input sequence of tokens as shown in block 420. Then, the input sequence is processed by two networks, which may operate concurrently. One network is referred to as a teacher network as shown in block 430, while the other network is referred to as a student network as shown in block 440. The teacher network may include a full-precision model associated with the quantized model. For instance, the quantized model may be derived from the full-precision model. In some embodiments, the teacher network may also be a trained model on the same task that the quantized model is trained on. As shown in block 430, the teacher network may include a series of layers, including an embedding layer 432, a plurality of transformer layers 434-436, and an embedding layer 438. The student network may include the quantized model to be trained. The quantized model may resemble the model architecture in the teacher network, for example by having the same number/type of layers. In this example, the student network has the same number of layers as that of the teacher network. Particularly, as shown in block 440, the student network also includes a series of layers, including an embedding layer 442, a plurality of transformer layers 444-446, and an embedding layer 448. The outputs of the teacher network and the student network may be compared as demonstrated in blocks 460 and 470.

In this example, superscripts s and t denote the student network and the teacher network, respectively. The length-n input sequence including n number of tokens is denoted as (t₁, t₂, . . . tₙ). For the i^{th} token tᵢ, the hidden states of the last transformer layers 446 and 436 from the student network and the teacher network, respectively, are linearly projected to token representations (hₜ_{ᵢ}^{s}, hₜ_{ᵢ}^{t})∈R^{d}. As shown in FIG. 4, a token memory bank (V_{b}) 450 may be coupled to the student network in block 440 to store momentum token representations from the quantized network. In some instances, the token memory bank 450 stores qₜ_{ᵢ}^{s} as smoothed representation of hₜ_{ᵢ}^{s} For each token of the quantized model, the representation of the same token from the full-precision teacher network may be defined as positive (or a positive sample), whereas representations of other tokens in the same input sequence are defined as negatives (or negative samples). Sᵢ denotes a union set including the index i of the positive and the indices of the sampled negatives for the i^{th} token tᵢ.

The token representations from the student network and the teacher network may be compared by applying a token-level contrastive distillation as shown in block 460. The goal of token-level contrastive distillation is to find a deviation of embedding learning between the student network and the teacher network, thereby guiding the quantized model to pull the tokens closer to their associated tokens generated by the full-precision model in the vector space and meanwhile to push away the other tokens in the input sequence. A legend 480 is provided to show the operations associated with “pull together” and “push away” between token representations. A token-level student-to-teacher contrastive distillation loss is denoted as [symbol] ₛ₂ₜ 462, which can be formulated for the length-n sequence as:

$${ℓ}_{s 2 t} = - {\sum }_{i = 1}^{n} log \frac{exp ( s ( {q}_{{t}_{i}}^{s} , {h}_{{t}_{i}}^{t} ) / τ )}{{\sum }_{j ∈ {s}_{i}} exp ( s ( {q}_{{t}_{i}}^{s} , {h}_{{t}_{j}}^{t} ) / τ )} , \qquad ( Eq . 5 )$$

where s(x,y)=x^{T}y/∥x|∥|y∥ computes a cosine similarity for vectors x and y, and τ is a fixed temperature parameter. In some embodiments, a memory bank may be used to store momentum token representations for the teacher network, and compute the teacher-to-student contrastive loss [symbol] ₜ₂ₛ. To this end, a final contrastive loss [symbol] _{cont} may be an aggregation of the contrastive losses from both sides, for example, by applying:

$${ℓ}_{c o n t} = \frac{1}{2} ( {ℓ}_{s 2 t} + {ℓ}_{t 2 s} ) . \qquad ( Eq . 6 )$$

In some embodiment, the final contrastive loss [symbol] _{cont} may be computed by applying any suitable weights to aggregate the contrastive losses from both sides. In some examples, when computing the contrastive distillation loss, the representations of negative samples may be loaded from the respective memory bank by applying low-cost indexing operations.

In some instances, the representation of token tᵢ in the respective memory bank (e.g., 450) may be updated based on a moving-average of token representations from the student network, which is referred to as a smooth operation formulated as:

qₜ_{ᵢ}^{s}←mqₜ_{ᵢ}^{s}(1−m)hₜ_{ᵢ}^{s}, (Eq. 7)

where m∈[0,1) is a momentum coefficient that controls the smoothness of the token representation.

Referring to block 470, another distillation loss may be computed based on logits provided by the teacher network and the student network. Logits in language model refer to the vectors of raw (i.e., non-normalized) predictions that a classification model generates. For the i^{th} token tᵢ, the logits of the quantized network and full-precision network are denoted as zₜ_{ᵢ}^{s}, zₜ_{ᵢ}^{t}∈R|V|, respectively, where |V| is vocabulary size. Vocabulary refers to the set of unique words used in a text corpus. The logits provided by the quantized network or full-precision network are associated with tokens generated by the respective network.

As shown in block 470, logits provided by the student network and the teacher network may be compared to obtain a distillation loss 472 denoted as [symbol] _{dist}. In this example, each of the logits provided by the student network is compared with a corresponding logit in the logits provide by the teacher network. Distillation loss [symbol] _{dist} 472 may be computed by applying a soft cross-entropy loss function as follows:

[symbol]

_{dist}=Σᵢ₌₁ⁿzₜ_{ᵢ}^{t} log(zₜ_{ᵢ}^{s}). (Eq. 8)

In this way, the total training loss [symbol] may be formulated as follows:

[symbol]

=λ [symbol] _{cont}+ [symbol] _{dist}, (Eq. 9)

where λ is a trade-off factor, which may be set as 0.1 by default and may be tunable by user inputs. The distillation loss [symbol] _{dist} and the contrastive loss [symbol] _{cont} provide information of different perspectives, thereby allowing the student network to obtain comprehensive information from the teacher network, thus improving the training performance of the student network. With knowledge of [symbol] _{dist}, the student network may learn to obtain tokens similar to the ones generated by the teacher network, by imitating each token based on the corresponding token generated by the teacher network. With knowledge of [symbol] _{cont}, the student network may learn not only to obtain tokens closer to the corresponding tokens (i.e., positives) generated by the teacher network in the vector space, but also to further differentiate the obtained tokens with other tokens (i.e., negatives) generated by the teacher network in the vector space.

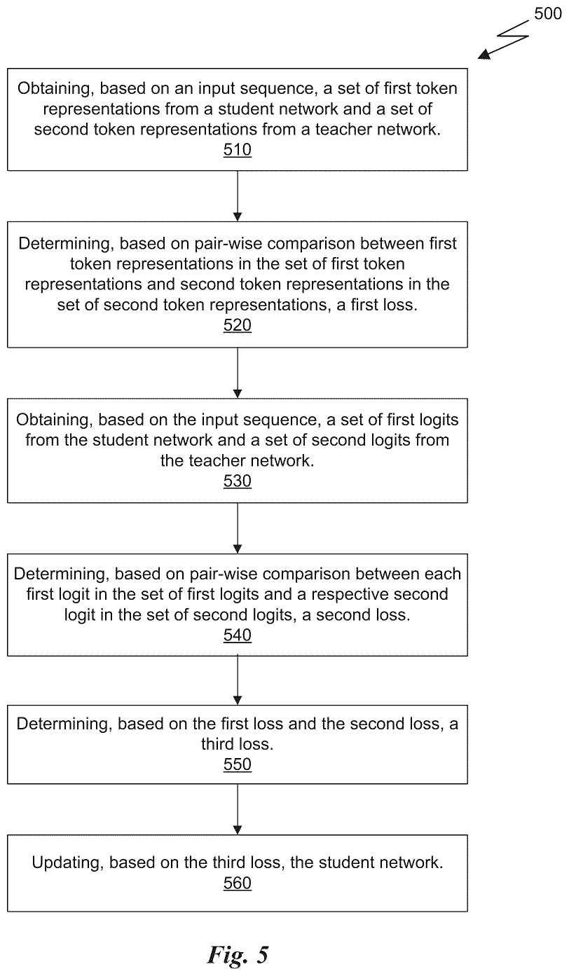

FIG. 5 is an exemplary process 500 of data processing, in accordance with one or more examples of the present disclosure. Process 500 may be performed by a processing system including one or more computer systems 150 as illustrated in FIG. 1B, which may be embodied as one or more client devices 120, one or more servers 130, or a combination thereof in network environment 100 as depicted in FIG. 1A. Process 500 may be performed alone or in combination with other processes in the present disclosure. It will be appreciated by one of skill in the art that process 500 may be performed in any suitable environment and in any suitable order.

In exemplary process 500 as demonstrated in FIG. 5, the processing system may be implemented with a workflow designed based on workflow 400 as demonstrated in FIG. 4. In the implemented workflow, a student network may include a quantized model, which may be quantized based on the method of module-dependent dynamic scaling by applying process 300.

At step 510, the processing system determines, based on an input sequence, a set of first token representations from a student network and a set of second token representations from a teacher network. As demonstrated in workflow 400, an input sequence may include a sequence of tokens. The input sequence may be processed by the student network and a teacher network in two branches.

At step 520, the processing system determines a first loss based on pair-wise comparisons between first token representations in the set of first token representations and second token representations in the set of second token representations. The processing system may compute the first loss based on the method of token-level contrastive distillation loss as demonstrated in workflow 400. In some examples, the processing system may compute the first loss by applying Equation 5 and/or Equation 6.

At step 530, the processing system determines, based on the input sequence, a set of first logits from the student network and a set of second logits from the teacher network.

At step 540, the processisng system determines a second loss based on a pair-wise comparison between each first logit in the set of first logits and a respective second logit in the set of second logits. The processing system may refer to block 470 in workflow 400 to compare the set of first logits and the set of second logits. In some instances, the processing system may compute the second loss by applying Equation 8.

At step 550, the processing system determines a third loss based on the first loss and the second loss. In some variations, the processing system may aggregated the first loss and the second loss by applying appropriate weights. For instance, the processing system may compute the third loss by applying Equation 9.

At step 550, the processisng system updates the student network based on the third loss. For example, the processing system may compute a gradient of the training loss (e.g., the third loss) with regard to the quantized weights in the quantized model (i.e., the student network), which may be used to compute updated weights in the model during the back propagation, thereby updating the weights in the model.

In some instances, the processing system may perform all or part of the steps in process 500 by a number of iterations, so that the quantized model may be fine-tuned for a specific task.

Additional details and advantages relating to exemplary embodiments of the present disclosure are discussed in Chaofan Tao, Lu Hou, Wei Zhang, Lifeng Shang, Xin Jiang, Qun Liu, Ping Luo, Ngai Wong (2022), “Compression of Generative Pre-trained Language Models via Quantization,” (available at arxiv.org/abs/2203.10705), which is hereby incorporated by reference in its entirety.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods/processes described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for quantizing a neural network model, performed by a processing system, comprising:
a) determining a scaling factor based on a distribution of weights associated with the neural network model;
b) determining quantized weights based on the scaling factor and the weights associated with the distribution;
c) determining, based on the quantized weights during training of the neural network model, a training loss of the neural network model; and
d) determining, based on a gradient of the training loss, an updated scaling factor for the neural network model.

2. The method according to claim 1, further comprising:
determining, based on the distribution of weights, an average weight magnitude; and
determining a clipping factor as a product of the scaling factor and the average weight magnitude,
wherein determining, based on the weights in the distribution and the scaling factor, quantized weights is based on the clipping factor.

3. The method according to claim 2, further comprising determining the average weight magnitude by an L1 norm function to the weights associated with the distribution.

4. The method according to claim 1, wherein the weights associated with the distribution are divided into a plurality of value ranges based on the scaling factor, the method further comprising:
computing a gradient contribution by each weight of the weights associated with the distribution based on the value range that the respective weight falls in; and
computing the gradient of the training loss by aggregating the gradient contributions from the weights associated with the distribution.

5. The method according to claim 1, further comprising:
setting an initial value of the scaling factor to one.

6. The method according to claim 1, further comprising:
determining, based on initial values of the weights in the neural network model, an initial value for the scaling factor.

7. The method according to claim 1, further comprising determining an optimized scaling factor for a task by carrying out multiple iterations of a) through d).

8. The method according to claim 1, wherein the updated scaling factor is associated with one weight matrix among a plurality of weight matrices in the neural network model, the method further comprising:
determining an updated scaling factor for each of the other weight matrices in the plurality of weight matrices in the neural network model by carrying out a) through d) for the respective weight matrix.

9. The method according to claim 8, further comprising:
applying the updated scaling factors to the neural network model;
determining quantized weights associated with the updated scaling factors as learnable weights in the neural network model; and
updating the neural network model by updating the learnable weights.

10. The method according to claim 9, wherein the neural network model with the quantized weights associated with the updated scaling factors is included in a student network, and the student network is trained with a teacher network, the method further comprising:
obtaining, based on an input sequence, a set of first token representations by the student network and a set of second token representations by the teacher network;
determining a first loss based on pair-wise comparison between first tokens in the set of first token representations and second tokens in the set of second token representations;
determining, based on the first loss, a third loss during training of the student network;
updating, based on the third loss, the student network.

11. The method according to claim 10, wherein the first loss comprises a student-to-teacher loss and a teacher-to-student loss.

12. The method according to claim 10, further comprising:
obtaining, based on the input sequence, a set of first logits from the student network and a set of second logits from the teacher network;
determining a second loss based on pair-wise comparison between each first logit in the set of first logits and respective second logit in the set of second logits; and
determining the third loss based on the first loss and the second loss.

13. The method according to claim 12, wherein the determining of the third loss based on the first loss and the second loss further comprises determining the third loss by aggregating the first loss and the second loss with a tunable factor.

14. A system for quantizing a neural network model, comprising:
one or more processors; and
a non-transitory computer-readable medium, having computer-executable instructions stored thereon, the computer-executable instructions, when executed by one or more processors, causing the one or more processors to facilitate:
a) determining a scaling factor based on a distribution of weights associated with the neural network model;
b) determining quantized weights based on the scaling factor and the weights associated with the distribution;
c) determining, based on the quantized weights during training of the neural network model, a training loss of the neural network model; and
d) determining, based on a gradient of the training loss, an updated scaling factor for the neural network model.

15. The system according to claim 14, wherein the one or more processors further facilitate:
determining, based on the distribution of weights, an average weight magnitude; and
determining a clipping factor as a product of the scaling factor and the average weight magnitude,
wherein determining, based on the weights in the distribution and the scaling factor, quantized weights is based on the clipping factor.

16. The system according to claim 14, wherein the weights associated with the distribution are divided into a plurality of value ranges based on the scaling factor, and wherein the one or more processors further facilitate:
computing a gradient contribution by each weight of the weights associated with the distribution based on the value range that the respective weight falls in; and
computing the gradient of the training loss by aggregating the gradient contributions from the weights associated with the distribution.

17. The system according to claim 14, wherein the updated scaling factor is associated with one weight matrix among a plurality of weight matrices in the neural network model, wherein the one or more processors further facilitate:
determining an updated scaling factor for each of the other weight matrices in the plurality of weight matrices in the neural network model by carrying out a) through d) for the respective weight matrix.

18. The system according to claim 17, wherein the one or more processors further facilitate:
applying the updated scaling factors to the neural network model;
determining quantized weights associated with the updated scaling factors as learnable weights in the neural network model; and
updating the neural network model by updating the learnable weights.

19. The system according to claim 18, wherein the neural network model with the quantized weights associated with the updated scaling factors is included in a student network, and the student network is trained with a teacher network, wherein the one or more processors further facilitate:
obtaining, based on an input sequence, a set of first token representations by the student network and a set of second token representations by the teacher network;
determining a first loss based on pair-wise comparison between first tokens in the set of first token representations and second tokens in the set of second token representations;
obtaining, based on the input sequence, a set of first logits from the student network and a set of second logits from the teacher network;
determining a second loss based on pair-wise comparison between each first logit in the set of first logits and respective second logit in the set of second logits;
determining, based on the first loss and the second loss, a third loss during training of the student network; and
updating, based on the third loss, the student network.

20. A non-transitory computer-readable medium, having computer-executable instructions stored thereon, for quantizing a neural network model, the computer-executable instructions, when executed by one or more processors, causing the one or more processors to facilitate:
a) determining a scaling factor based on a distribution of weights associated with the neural network model;
b) determining quantized weights based on the scaling factor and the weights associated with the distribution;
c) determining, based on the quantized weights during training of the neural network model, a training loss of the neural network model; and
d) determining, based on a gradient of the training loss, an updated scaling factor for the neural network model.
